(19) United States
(12) Patent Application Publication
(10) Pub. No.: US 2026/0223099 A1
(43) Pub. Date: Jul. 30, 2026

(54) RESOURCE POOL CONFIGURATION FOR SHARED CONFIGURED GRANT

(71) Applicant: QUALCOMM Incorporated, San Diego, CA (US)

(72) Inventors: Qing LI, Princeton Junction, NJ (US); Linhai HE, San Diego, CA (US); Jing SUN, San Diego, CA (US); Gavin Bernard HORN, La Jolla, CA (US); Ozcan OZTURK, San Diego, CA (US)

(21) Appl. No.: 19/283,446

(22) Filed: Jul. 29, 2025

Related U.S. Application Data
(60) Provisional application No. 63/749,406, filed on Jan. 24, 2025.

(51) Int. Cl. H04W 72/115; H04W 72/0453; H04W 72/21

(52) U.S. Cl. CPC H04W 72/115; H04W 72/0453; H04W 72/21

(57) ABSTRACT

Various aspects of the present disclosure generally relate to wireless communication. In some aspects, a user equipment (UE) may receive an identifier (ID) for the UE and a resource pool configuration associated with a configured grant shared by multiple UEs. The UE may transmit an uplink transmission based at least in part on the ID and the resource pool configuration. Numerous other aspects are described.

### CROSS-REFERENCE TO RELATED APPLICATION

This Patent Application claims priority to U.S. Provisional Patent Application No. 63/749,406, filed on Jan. 24, 2025, entitled “RESOURCE POOL CONFIGURATION FOR SHARED CONFIGURED GRANT,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with a resource pool configuration for shared configured grant.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

Some aspects described herein relate to a method of wireless communication performed by a user equipment (UE). The method may include receiving an identifier (ID) for the UE and a resource pool configuration associated with a configured grant shared by multiple UEs. The method may include transmitting an uplink transmission based at least in part on the ID and the resource pool configuration.

Some aspects described herein relate to a method of wireless communication performed by a network entity. The method may include transmitting an ID for a UE and a resource pool configuration associated with a configured grant shared by multiple UEs. The method may include receiving, in association with the resource pool configuration, an uplink transmission.

Some aspects described herein relate to a UE. The UE may include a processing system. The processing system may include one or more processors and one or more code-storing memories coupled with the one or more processors. The processing system may be configured to cause the UE to receive an ID for the UE and a resource pool configuration associated with a configured grant shared by multiple UEs. The processing system may be configured to cause the UE to transmit an uplink transmission based at least in part on the ID and the resource pool configuration.

Some aspects described herein relate to a network entity. The network entity may include a processing system. The processing system may include one or more processors and one or more code-storing memories coupled with the one or more processors. The processing system may be configured to cause the network entity to transmit an ID for a UE and a resource pool configuration associated with a configured grant shared by multiple UEs. The processing system may be configured to cause the network entity to receive, in association with the resource pool configuration, an uplink transmission.

Some aspects described herein relate to a non-transitory computer-readable medium that stores a set of instructions for wireless communication by a UE. The set of instructions, when executed by one or more processors of the UE, may cause the UE to receive an ID for the UE and a resource pool configuration associated with a configured grant shared by multiple UEs. The set of instructions, when executed by one or more processors of the UE, may cause the UE to transmit an uplink transmission based at least in part on the ID and the resource pool configuration.

Some aspects described herein relate to a non-transitory computer-readable medium that stores a set of instructions for wireless communication by a network entity. The set of instructions, when executed by one or more processors of the network entity, may cause the network entity to transmit an ID for a UE and a resource pool configuration associated with a configured grant shared by multiple UEs. The set of instructions, when executed by one or more processors of the network entity, may cause the network entity to receive, in association with the resource pool configuration, an uplink transmission.

Some aspects described herein relate to an apparatus for wireless communication. The apparatus may include means for receiving an ID for the apparatus and a resource pool configuration associated with a configured grant shared by multiple apparatuses. The apparatus may include means for transmitting an uplink transmission based at least in part on the ID and the resource pool configuration.

Some aspects described herein relate to an apparatus for wireless communication. The apparatus may include means for transmitting an ID for another apparatus and a resource pool configuration associated with a configured grant shared by multiple apparatuses. The apparatus may include means for receiving, in association with the resource pool configuration, an uplink transmission.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings, and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIG. 3 is a diagram illustrating an example of configured grant (CG) communication.

FIG. 4 is a diagram illustrating an example of multiple CG configurations, in accordance with the present disclosure.

FIG. 5 is a diagram illustrating an example of uplink transmission allocation, in accordance with the present disclosure.

FIG. 6 is a diagram illustrating an example of synchronization signal block (SSB)-based resource allocations, in accordance with the present disclosure.

FIG. 7 is a diagram illustrating an example of small data allocations, in accordance with the present disclosure.

FIG. 8 is a diagram illustrating an example of SSB-based resource allocations, in accordance with the present disclosure.

FIG. 9 is a diagram illustrating an example of resource pool management, in accordance with the present disclosure.

FIG. 10 is a diagram illustrating an example process performed, for example, at a user equipment (UE) or an apparatus of a UE, in accordance with the present disclosure.

FIG. 11 is a diagram illustrating an example process performed, for example, at a network entity or an apparatus of a network entity, in accordance with the present disclosure.

FIG. 12 is a diagram of an example apparatus for wireless communication.

FIG. 13 is a diagram of an example apparatus for wireless communication.

### DETAILED DESCRIPTION

A network entity may transmit a configured grant (CG) configuration to a user equipment (UE). For example, the network entity may transmit configuration information that identifies the CG. In some aspects, the configuration information identifying the CG may indicate a resource allocation (e.g., in a time domain, frequency domain, spatial domain, or code domain) or a periodicity associated with the resource allocation. The CG may identify a resource or set of resources available to the UE for transmission of an uplink communication (e.g., data or control information). For example, the CG configuration may identify a resource allocation to the UE for a physical uplink shared channel (PUSCH) message.

Uplink (UL) CG may involve control signaling overhead (e.g., especially for small data transmission), and/or latency. A UE may be configured with multiple CG configurations with dedicated resource allocations, such as a number of contiguous slots within a period for a configuration within one UL bandwidth part (BWP). While UL CG improves the signaling overhead and latency, the dedicated resource utilization may not be optimized.

To improve resource utilization, configured resources may be shared among multiple UEs. For example, the CG configuration may identify one or multiple resource pools that may be available to multiple UEs for an uplink transmission. In some aspects, there may be collisions among UEs selecting the same resource(s), and the blind decoding overhead at the network entity may increase, consuming power and signaling resources.

Various aspects relate generally to CG. Some aspects more specifically relate to a network entity may transmit an identifier (ID) for the UE and one or more resource pool configurations, where each resource pool configuration includes the parameters of uplink resource allocations for uplink transmissions, such as small data transmissions or uplink control information (UCI) that indicates resources for PUSCH messages. The resource pool configuration may be associated with a CG shared by multiple UEs. The resource pool configuration may, for example, indicate a size (e.g., a quantity of symbols, mini-slots, or slots in time and a quantity of physical resource blocks (PRBs) in frequency) of an uplink transmission. The resource pool configuration may also indicate a quantity of transmission occasions within a period of a resource pool. The UE may select time and frequency resources for an uplink transmission based at least in part on the resource pool configuration. The UE may transmit the uplink transmission in the selected resources.

Particular aspects of the subject matter described in this disclosure can be implemented to realize one or more of the following potential advantages. By using the resource pool configuration for uplink transmissions with shared CG, the network entity may reduce overhead for the network entity and conserve signaling resources and processing resources.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

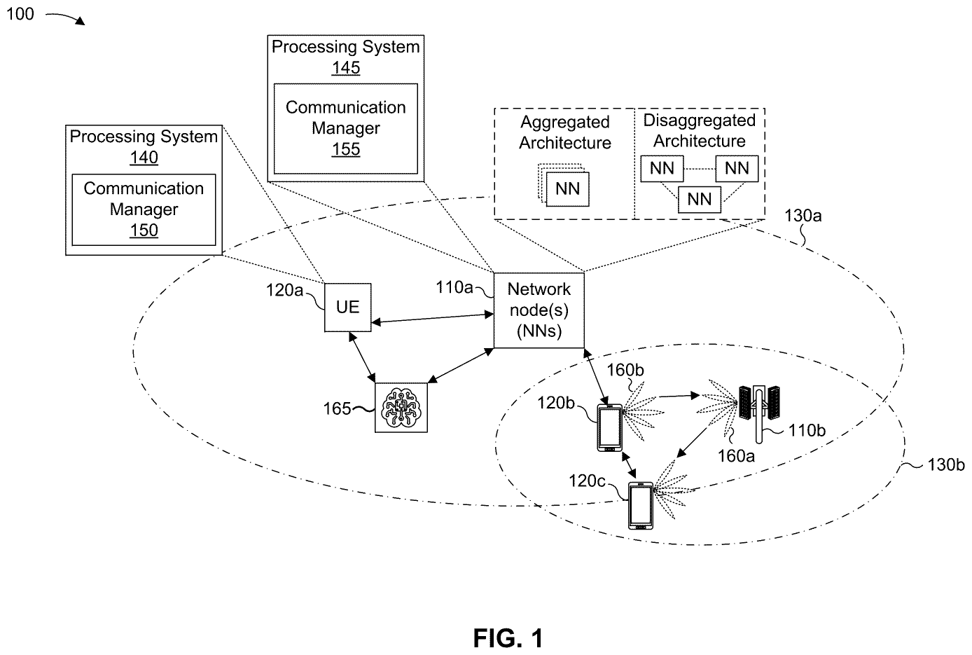

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit UCI from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, a UE (e.g., a UE 120) may include a communication manager 150. As described in more detail elsewhere herein, the communication manager 150 may receive an ID for the UE and one or more resource pool configurations associated with a configured grant shared by multiple UEs; and transmit an uplink transmission based at least in part on the ID and the one or more resource pool configurations. Additionally, or alternatively, the communication manager 150 may perform one or more other operations described herein.

In some aspects, a network entity (e.g., a network node 110) may include a communication manager 155. As described in more detail elsewhere herein, the communication manager 155 may transmit an ID for a UE and one or more resource pool configurations associated with a configured grant shared by multiple UEs; and receive, in association with the ID and the one or more resource pool configurations, an uplink transmission. Additionally, or alternatively, the communication manager 155 may perform one or more other operations described herein.

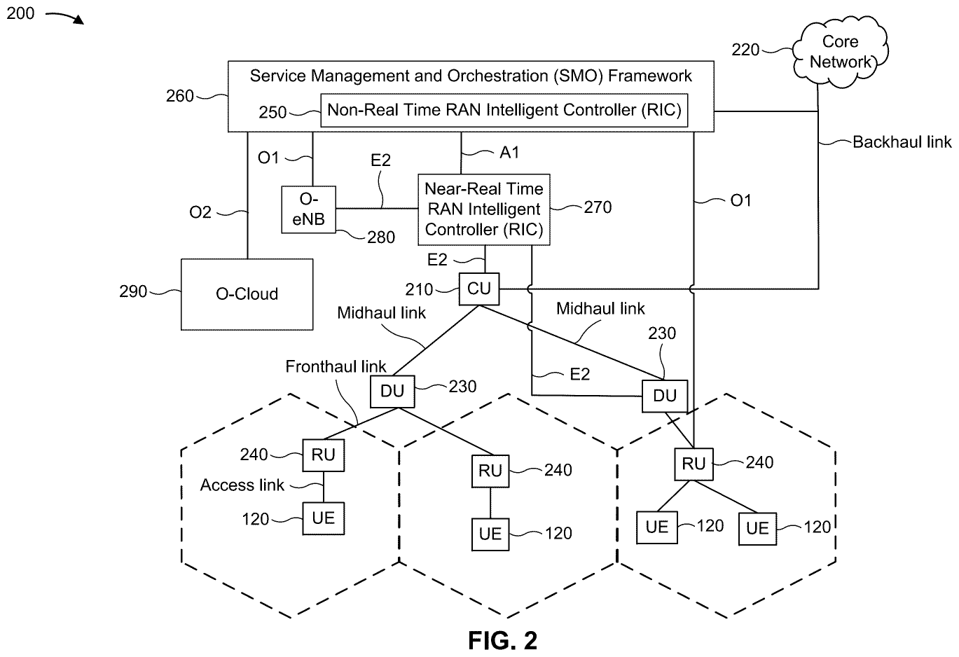

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

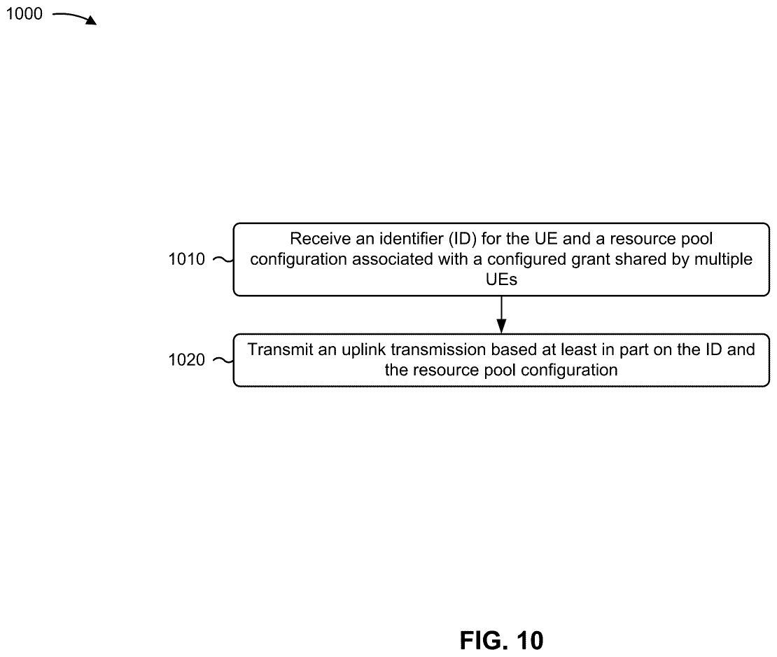

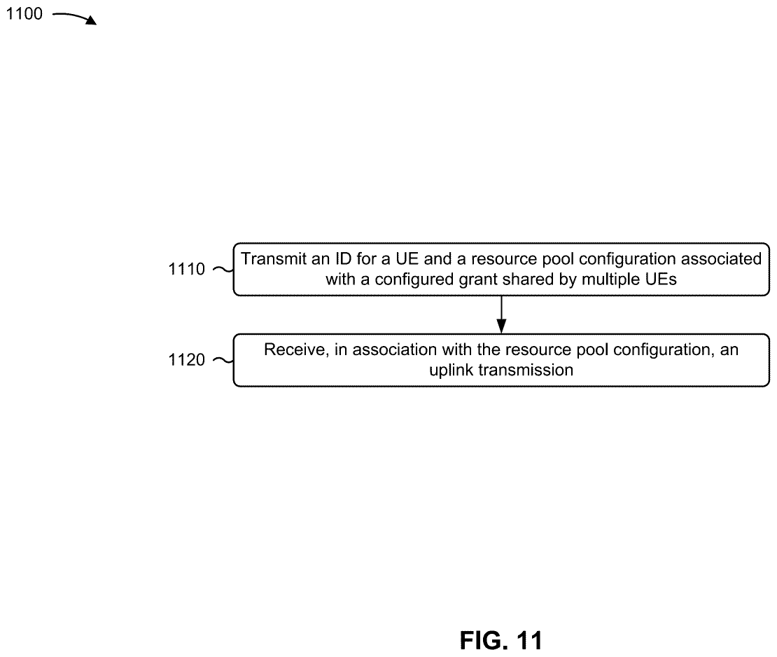

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with resource pool configurations for shared CG, as described in more detail elsewhere herein. For example, the processing system 145 of the network node 110, the processing system 140 of the UE 120, the CU 210, the DU 230, or the RU 240 may perform or direct operations of, for example, process 1000 of FIG. 10, process 1100 of FIG. 11, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 1000 of FIG. 10, process 1100 of FIG. 11, or other processes as described herein. In some examples, executing instructions may include running the instructions, converting the instructions, compiling the instructions, or interpreting the instructions, among other examples.

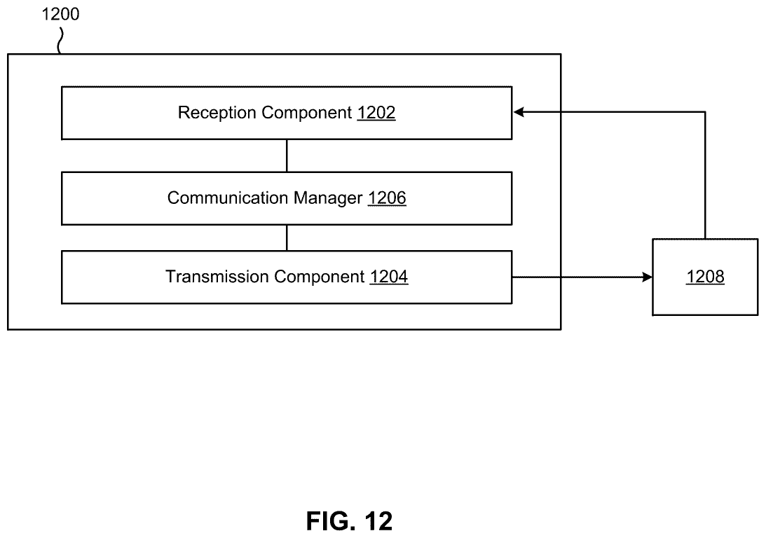

In some aspects, a UE (e.g., a UE 120) includes means for receiving an ID for the UE and one or more resource pool configurations associated with a configured grant shared by multiple UEs; and/or means for transmitting an uplink transmission based at least in part on the ID and the one or more resource pool configurations. The means for the UE to perform operations described herein may include, for example, one or more of communication manager 150, processing system 140, a radio, one or more RF chains, one or more transceivers, one or more antennas, one or more modems, a reception component (for example, reception component 1202 depicted and described in connection with FIG. 12), or a transmission component (for example, transmission component 1204 depicted and described in connection with FIG. 12), among other examples.

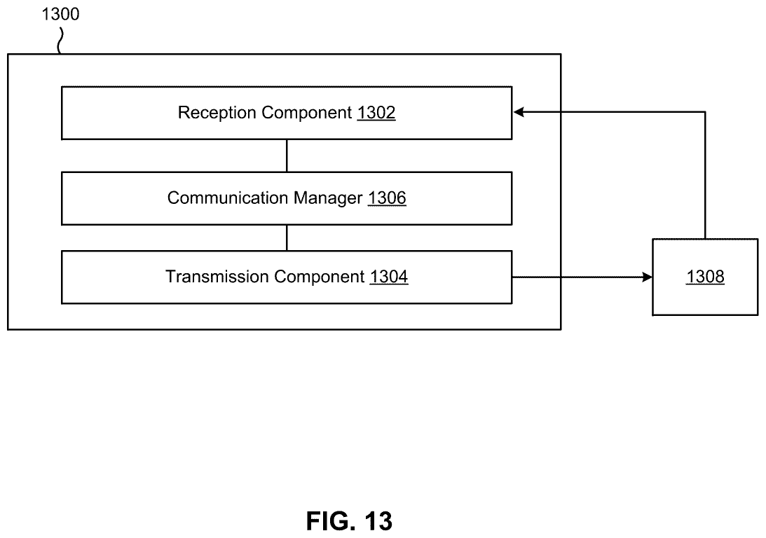

In some aspects, a network entity (e.g., a network node 110) includes means for transmitting an ID for a UE and one or more resource pool configurations associated with a configured grant shared by multiple UEs; and/or means for receiving, in association with the ID and the one or more resource pool configurations, an uplink transmission. In some aspects, the means for the network entity to perform operations described herein may include, for example, one or more of communication manager 155, processing system 145, a radio, one or more RF chains, one or more transceivers, one or more antennas, one or more modems, a reception component (for example, reception component 1302 depicted and described in connection with FIG. 13), or a transmission component (for example, transmission component 1304 depicted and described in connection with FIG. 13), among other examples.

Usage scenarios for devices may include integrated sensing and communication, immersive communication, AI and communication, massive communication, ubiquitous connectivity, and hyper-reliable low-latency communication. Devices and systems for such scenarios are to be designed for different capabilities, including for low user plane latency, low control plane latency, and high connection density.

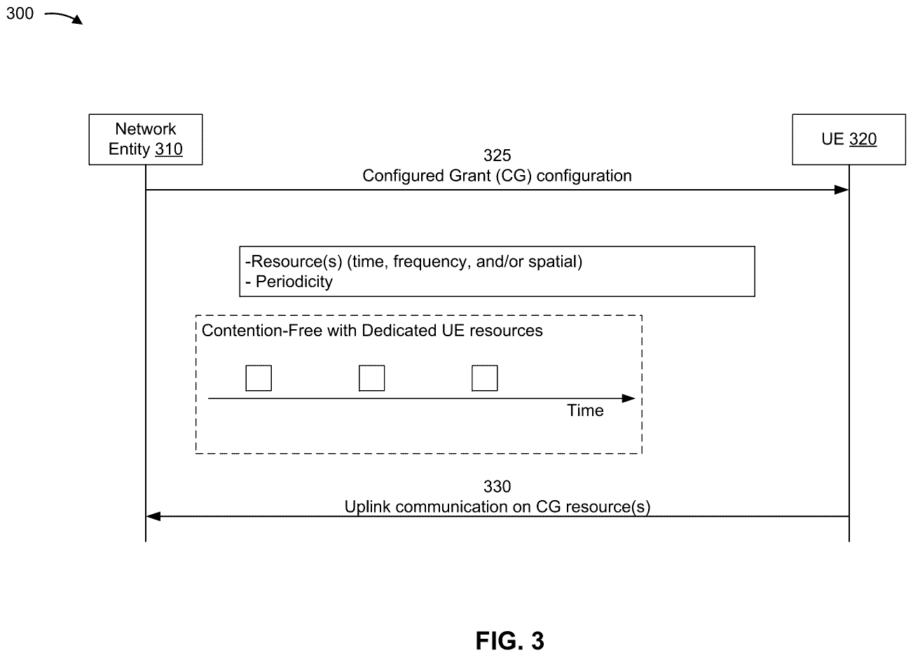

FIG. 3 is a diagram illustrating an example 300 of configured grant (CG) communication. As shown, example 300 includes a network entity 310 and a UE 320.

As shown in FIG. 3, and by reference number 325, the network entity may transmit a CG configuration to the UE. For example, the network entity 310 may transmit configuration information (e.g., in a radio resource configuration (RRC) message, in a downlink control information message, or in another signaling message) that identifies the CG. In some aspects, the configuration information identifying the CG may indicate a resource allocation (e.g., in a time domain, frequency domain, spatial domain, or code domain) or a periodicity associated with the resource allocation. The CG may identify a resource or set of resources available to the UE for transmission of an uplink communication (e.g., data or control information). For example, the CG configuration may identify a resource allocation for a PUSCH.

In some aspects, the CG configuration may configure contention-free CG communication with resources dedicated for the UE to transmit uplink communications. In this case, the CG configuration may indicate a resource allocation (e.g., in a time domain, frequency domain, spatial domain, or code domain) dedicated for the UE to use to transmit uplink communications. In some aspects, the CG configuration may configure the resource allocation for the UE to occur periodically, such that the resource allocation corresponds to periodically occurring transmission time occasions. As shown in FIG. 3, and by reference number 330, when the UE has uplink data to transmit, the UE transmits the uplink data in the CG resources identified by the CG configuration. For example, the UE transmits the uplink data in one of the CG uplink occasions identified in the CG configuration using the configured resource allocation.

A CG configuration with regular periodic CG uplink occasions with a dedicated resource allocation for the UE may be convenient for a UE with periodic uplink traffic (e.g., with trivial jitter). The CG configuration may configure the periodicity associated with the resource allocation to associate CG uplink occasions with periodic nominal arrival times at which traffic to be transmitted to the network entity 310 is expected to arrive at (or be ready to be transmitted by) the UE. However, the actual arrival times at which the traffic arrives (or is ready to be transmitted) by the UE may be different than the nominal arrival times, and this difference in times is known as jitter. In some aspects, traffic jittering may be handled by configuring multiple CG configurations around the nominal arrival times. In some aspects, multiple opportunities for the UE to transmit the uplink communication may be defined within a CG uplink occasion. The UE may be configured with multiple CG configurations to allow the UE to transmit multiple CG uplink communications and increase the likelihood that the network entity 310 receives the communications. NR CG uplink may depend on dynamic grant re-transmission. In some aspects, to suppress a quantity of dynamic grants, the CG can be configured with blind re-transmissions via multiple repetitions.

In some cases, CG configurations with dedicated resources allocated per UE may be inefficient. For example, CG configurations with dedicated UE resources for a large number of UEs may result in consumption of an excessive amount of PUSCH resources. In this case, a considerable portion of the PUSCH resources may be inefficiently utilized, which reduces system capacity. For example, when multiple CG configurations for a UE are used for de-jittering, only a subset of CG resources may be effectively utilized. In another example, when multiple transmission opportunities are defined per CG uplink occasion, only one opportunity may be effectively utilized. In yet another example, when a blind repetition scheme is used for re-transmissions, a packet may have been already decoded after the first one or more repetitions (early decoding) such that a remainder of the repetitions are unnecessary. Unlike a downlink case, this type of inefficient consumption of system resources cannot be addressed by scheduling, as the network entity 310 does not know exactly when traffic will arrive at the UEs.

As indicated above, FIG. 3 is provided as an example. Other examples may differ from what is described with respect to FIG. 3.

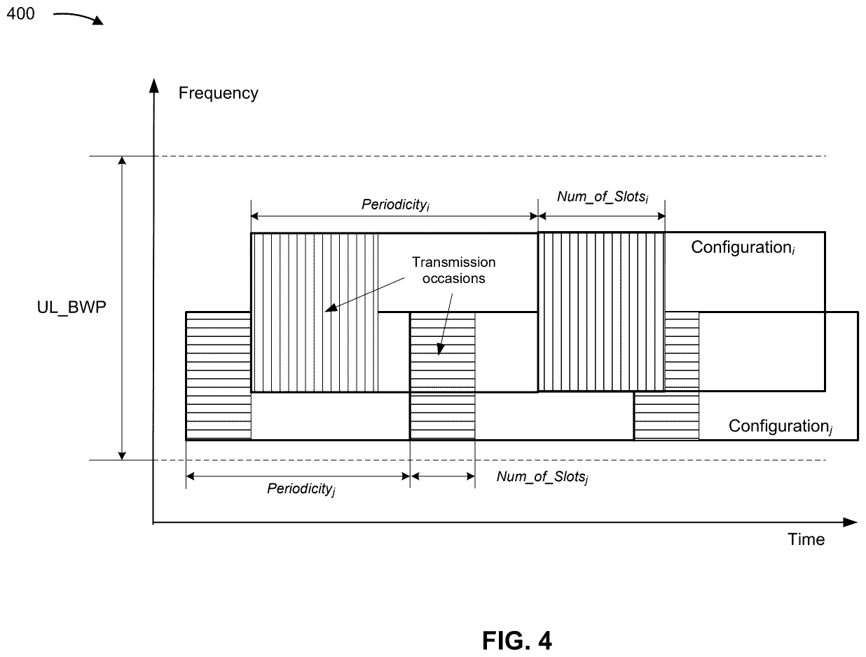

FIG. 4 is a diagram illustrating an example 400 of multiple CG configurations, in accordance with the present disclosure.

UL CG may involve control signaling overhead (e.g., especially for small data transmission), and/or latency (e.g., compared with SR-based dynamic grant). A UE (e.g., UE 320) may be configured with multiple CG configurations with dedicated resource allocations, such as a number of contiguous slots (e.g., Num_of_Slotsᵢ or Num_of Slotsⱼ) within a period (e.g., Periodicityᵢ or Periodicityⱼ) for a configuration (e.g., Configurationᵢ or Configurationⱼ) within one UL BWP, as shown in example 400.

Example 400 shows there may be a quantity of transmission occasions (of a CG configuration), which may include transmission occasions in time (e.g., slots) and in frequency (e.g., PRBs). Each CG configuration may include a periodicity and a quantity of slots that can be used for uplink transmission.

While UL CG improves the signaling overhead and latency, the dedicated resource utilization may not be optimized. For 6G, with an increased connection density for more devices, multiple UL CGs with dedicated resources for a massive amount of UEs may be very wasteful. Furthermore, with a more shortened latency for 6G, one CG with a fixed period may also limit a UE's immediate transmission with arrival data. To improve resource utilization, and to further improve latency, UL CG resources may be shared with UEs. For example, UEs may share one or more CG resource sets or resource pools. However, there may be collisions among UEs selecting the same resource(s), and the blind decoding overhead at the network entity may increase, consuming power and signaling resources.

As indicated above, FIG. 4 is provided as an example. Other examples may differ from what is described with regard to FIG. 4.

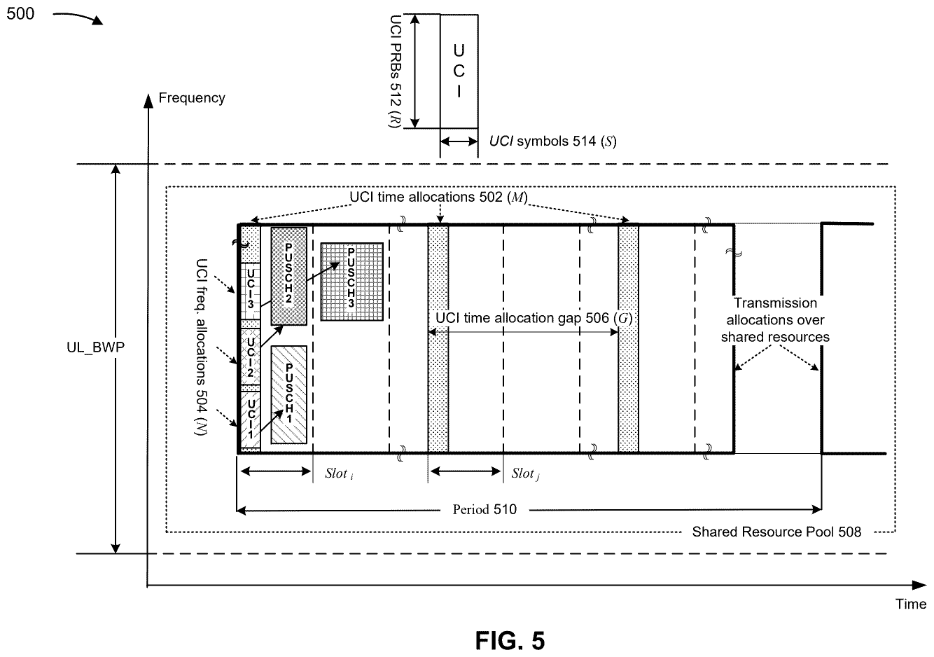

FIG. 5 is a diagram illustrating an example 500 of uplink transmission allocation, in accordance with the present disclosure.

According to various aspects described herein, a network entity may transmit an ID for the UE and one or more resource pool configurations, where each resource pool configuration includes the parameters of uplink resource allocations for uplink transmissions, such as small data transmissions or UCI that indicates resources for PUSCH messages. The resource pool configuration may be associated with a CG shared by multiple UEs. The resource pool configuration may, for example, indicate a size (e.g., a quantity of symbols or mini-slots or slots in time, a quantity of PRBs in frequency) of an uplink transmission. The resource pool configuration may also indicate a quantity of transmission occasions within a period of a resource pool. The UE may select time and frequency resources for an uplink transmission based at least in part on the resource pool configuration. The UE may transmit the uplink transmission in the selected resources. By using the resource pool configuration for uplink transmissions with shared CG, the network entity may reduce overhead for the network entity and conserve signaling resources and processing resources.

Example 500 shows an example of a resource pool configuration for an uplink transmission, such as UCI. The resource pool configuration may include a parameter for periodicity (e.g., period 510) with transmission allocations over shared resources, a parameter for UCI time allocations 502 (e.g., quantity M of UCI time allocations) of each period within the shared resource pool 508, a parameter for UCI frequency allocations 504 (e.g., quantity N of UCI frequency allocations) within the shared resource pool 508, and a parameter G for a UCI time allocation gap 506 (e.g., quantity G of slots or mini-slots) between two adjacent UCI time allocations. Additionally, the resource pool configuration may include a parameter for UCI PRBs 512 (e.g., quantity R PRBs of a UCI size in frequency) and/or a parameter for UCI symbols 514 (e.g., quantity S symbols of a UCI size in time).

In some aspects, the UE may select a time resource (e.g., a slot or a mini-slot) for a UCI transmission allocation in time. The UE may select the time resource (e.g., a UCI time allocation of the M UCI time allocations within a period of a shared resource pool) based at least in part on the UE ID and the resource pool configuration (e.g., parameters M, N, and G, or the like). For example, the UE may select a time resource in slot for a UCI transmission based at least in part on the (UE_ID mod M) times G (e.g., with G in slots). The modulo operation reflects the wraparound of the time allocations M of a period 510 within the shared resource pool 508. With multiple UEs, there may be a UE_IDₐ for the UEₐ and a UE_ID_{b} for another UE_{b}, such that UCI_{slot,a}=(UE_IDₐ₁ mod M)×Gₛₗₒₜ for UEₐ and UCI_{slot,b}=(UE_ID_{b1} mod M)×Gₛₗₒₜ for UE_{b}, where the UE_IDₐ₁ and UE_ID_{b1} may be a subset of the ID bits of the respective UE_IDₐ and UE_ID_{b}. For example, UE_ID may be split into two subsets such as UE_ID₁ and UE_ID₂ (e.g., the UE_ID₁ may be a subset contains a number of least significant bits (LSBs) or most significant bits (MSBs) of the UE_ID bits and the UE_ID₂ may be another subset contains the remaining MSBs or LSBs of the UE_ID bits), where the UE_ID that is split according to a cell radio network temporary identifier (C-RNTI) for the UE at an RRC-connected state, a stored C-RNTI for the UE at an RRC-inactive state, or a UE ID assigned by a network entity for resource selection. In another example, the UE may select a time resource in min-slot for a UCI transmission based at least in part on the (UE_ID mod M) times G (e.g., with G in mini-slots). In this case, the UCI transmission in time for UEₐ and UE_{b} may be allocated respectively with UCI_{mini-slot,a}=(UE_IDₐ₁ mod M)×Gₘᵢₙᵢ₋ₛₗₒₜ and UCI_{mini-slot,b}=(UE_ID_{b1} mod M)×Gₘᵢₙᵢ₋ₛₗₒₜ. Based at least in part on the selected time allocation (e.g., UCIₛₗₒₜ in slot or UCIₘᵢₙᵢ₋ₛₗₒₜ in mini-slot), a UE may transmit a UCI at the first S symbols within the allocated slot or mini-slot (e.g., UCI 1 or UCI2 or UCI3 at the first S symbols within Slotᵢ) within a period of a shared resource pool.

The UE may select a frequency resource (e.g., R PRBs) for a UCI transmission allocation in frequency. The UE may select the frequency resource (e.g., a UCI frequency allocation of the N UCI frequency allocations within a shared resource pool) based at least in part on the UE ID and the resource pool configuration (e.g., parameters M, N, and G, or the like). In some aspects, the UE may select a frequency allocation for a UCI transmission based at least in part on the (UE_ID mod N)×R. The modulo operation reflects the wraparound of the frequency allocations N within the shared resource pool 508. With multiple UEs, there may be a UE_IDₐ for the UEₐ and a UE_ID_{b} for another UE_{b}, such that UCI_{PRB,a}=(UE_IDₐ₂ mod N)×R_{PRB} for UEₐ and UCI_{PRB,b}=(UE_ID_{b2} mod N)×R_{PRB} for UE_{b}, where the UE_IDₐ₂ and UE_ID_{b2} may be a subset of the ID bits of the respective UE_IDₐ and UE_ID_{b}. For example, UE_ID may be split into two subsets such as UE_ID₁ and UE_ID₂ (e.g., the UE_ID₁ may be a subset contains a number of LSBs or MSBs of the UE_ID bits and the UE_ID₂ may be another subset contains the remaining MSBs or LSBs of the UE_ID bits). In some aspects, the UE may select a frequency allocation for a UCI transmission based at least in part on the UCI_{PRB}=random (N)×R_{PRB}, where random (N) is a random function selecting one frequency allocation from the N allocations. For example, a UE may randomly select a frequency allocation from the UCI frequency allocations 504, based at least in part on the UE ID (e.g., a random seed associated with the UE ID). Based at least in part on the selected UCI frequency allocation (e.g., UCI_{PRB}), a UE may transmit a UCI with R PRBs starting from the allocated PRB (e.g., UCI1 at the first UCI frequency allocation or UCI2 at the second UCI frequency allocation or UCI3 at the third UCI frequency allocation within Slotᵢ) within a shared resource pool.

In some aspects, the subset of a UE ID (e.g., UE_ID₁ or UE_ID₂) may be the full set of UE ID bits (e.g., UE_ID₁=UE_ID or UE_ID₂=UE_ID).

As indicated above, FIG. 5 is provided as an example. Other examples may differ from what is described with regard to FIG. 5.

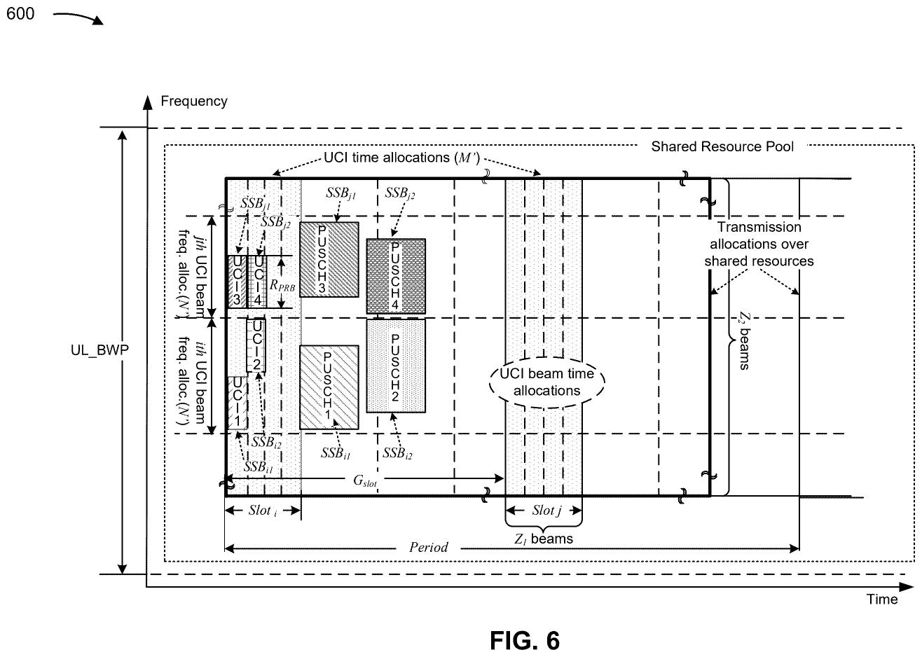

FIG. 6 is a diagram illustrating an example 600 of SSB-based resource allocations, in accordance with the present disclosure.

In some aspects, a UE may reduce blind beam sweeping at the network entity by selecting resources that are based at least in part on the beams associated with SSB transmissions of an SSB burst. For example, beam-based uplink transmission allocations may be based at least in part on allocations associated with time division multiplexed (TDMed) beams. There may be M′ UCI transmission occasions in time within a period of a shared resource pool, where each transmission occasion includes Z₁ beam time allocations (e.g., each beam using 1~2 symbols within a slot such as slotᵢ or slotⱼ) associated with the beams corresponding to Z₁ SSBs. Beam-based UCI transmission allocations may be based at least in part on allocations of frequency division multiplexed (FDMed) beams. There may be multiple N′ UCI transmission occasions in frequency within a share resource pool, where each of the N′ UCI transmission occasions corresponds to a beam frequency allocation at a time that is associated with an SSB (e.g., Z₂ beam allocations in frequency respectively with Z₂ SSBs). For example, the ith N′ UCI beam frequency allocations are associated with SSBᵢ or the jth N′ UCI beam frequency allocations are associated with SSBⱼ.

The UE may receive an indication of one or more resource pool configurations, where each resource pool configuration may indicate uplink transmission allocations that are based at least in part on beams associated with SSB transmissions. For example, UCI resource selection may be based at least in part on the beam associated with the best selected SSB (e.g., TDMed beams (different beams at different time allocations at a same frequency allocation, such as the beams associated with SSBᵢ₁ and SSBᵢ₂ or SSBⱼ₁ and SSBⱼ₂) or FDMed beams (different beams at different frequency allocations at a same time allocation, such as the beams associated with SSBᵢ₁ and SSBⱼ₁ or SSBᵢ₂ and SSBⱼ₂)), as shown by example 600.

The network entity may transmit SSBs with different transmit beams. The SSB1 on transmit beam 1 from the network entity may be the best SSB and received on receive beam 1 at a first UE. The SSB4 on transmit beam 4 from the network entity may be the best SSB and received on receive beam 4 at a second UE. The UCI1 on transmit beam 1 (corresponding the receive beam 1 for SSB1) from the first UE may be received on receive beam 1 (corresponding to the transmit beam 1 for SSB1) at the network entity. The UCI4 on transmit beam 4 (corresponding the receive beam 4 for SSB4) from the second UE may be received on receive beam 4 (corresponding to the transmit beam 4 for SSB4) at the network entity. That is, the UCI may be transmitted from a UE with the transmit beam corresponding to the receive beam associated with an SSB at a UCI transmitting allocation in time and frequency which is associated with the SSB, and the UCI may be monitored at the network entity with the receive beam corresponding to the transmit beam associated with an SSB at a UCI monitoring allocation in time and frequency which is associated with the SSB.

In some aspects, the UE may select an uplink transmission allocation, which may include a time resource that is based at least in part on a beam time allocation associated with a beam of an SSB transmission. For example, the UE may select a beam time allocation corresponding to an SSBₖ (e.g., SSBᵢ₁ or SSBᵢ₂ within the ith N′ UCI beam frequency allocations or SSBⱼ₁ or SSBⱼ₂ with the jth N′ UCI beam frequency allocations) within a UCI transmission allocation in time (e.g., slotᵢ) for a UCI transmission based at least in part on UCI_{slot,SSBk}=(UE_ID₁ mod M′)×G_{slot,SSBk}. Based at least in part on the selected UCI beam time allocation within a UCI time allocation (e.g., slotᵢ), a UE may transmit a UCI at the UCI symbols of the selected UCI beam time allocation (e.g., the UCI1 symbols associated with SSBᵢ₁ or the UCI2 symbols associated with SSBᵢ₂) within a period of a shared resource pool.

In some aspects, the UE may select an uplink transmission allocation, which may include a frequency resource that is based at least in part on a beam frequency allocation associated with a beam of an SSB transmission. For example, the UE may select a beam frequency allocation corresponding to an SSBₗ (e.g., SSBᵢ₁ or SSBⱼ₁ at the first UCI beam time allocation or SSBᵢ₂ or SSBⱼ₂ at the second UCI beam time allocation) within a UCI transmission allocation in time (e.g., slotᵢ) for a UCI transmission based at least in part on UCI_{PRB, SSBl}=(UE_ID₂ mod N′)×R_{PRB,SSBl}. In another example, the UE may randomly select a beam frequency allocation corresponding to an SSBₗ (e.g., SSBᵢ₁ or SSBⱼ₁ at the first UCI beam time allocation or SSBᵢ₂ or SSBⱼ₂ at the second UCI beam time allocation) within a UCI transmission allocation in time (e.g., slotᵢ) for a UCI transmission based at least in part on UCI_{PRB,SSBl}=random (N′)×R_{PRB,SSBl}. In this case, the UE may randomly select R PRBs within the ith N′ UCI beam frequency allocations (e.g., corresponding to SSBᵢ) or R PRBs within the jth N′ UCI beam frequency allocations (e.g., corresponding to SSBⱼ). Based at least in part on the selected UCI beam frequency allocation with a N′ UCI beam frequency allocations (e.g., the ith N′ UCI beam frequency allocations or the jth N′ UCI beam frequency allocations), a UE may transmit a UCI at the UCI PRBs of the selected UCI beam frequency allocation (e.g., the UCI1 PRBs associated with SSBᵢ₁ or the UCI3 PRBs associated with SSBⱼ₁) within a UCI transmission allocation in time (e.g., slotᵢ) of a shared resource pool.

As indicated above, FIG. 6 is provided as an example. Other examples may differ from what is described with regard to FIG. 6.

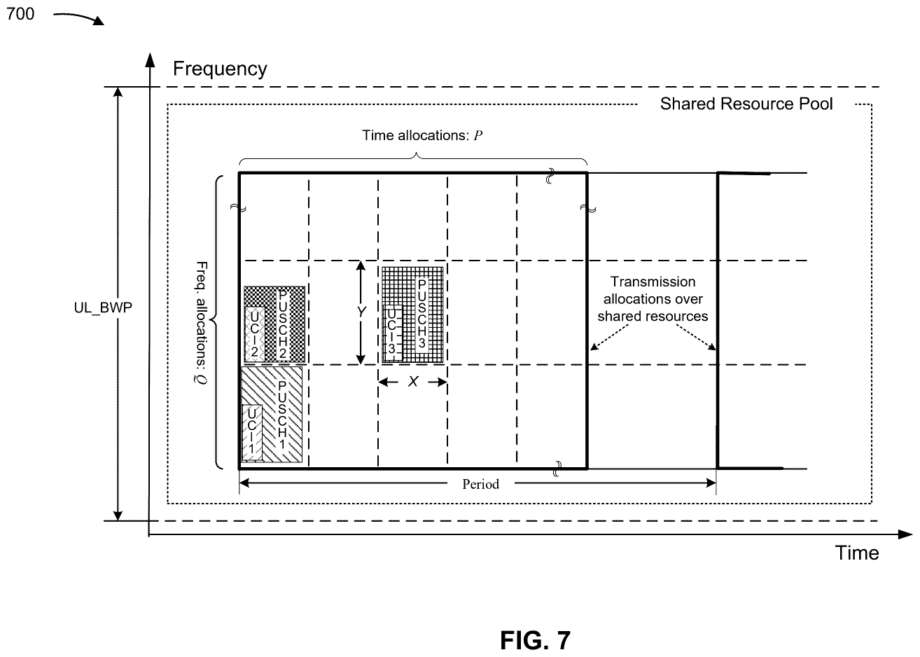

FIG. 7 is a diagram illustrating an example 700 of small data allocations, in accordance with the present disclosure.

In some aspects, the UE may reduce the collisions of small data transmissions and reduce the latency of a control plane or a data plane. The network entity may transmit one or more resource pool configurations where each resource pool configuration contains the parameters for uplink transmissions with small data. In some aspects, the small data transmission may include a UCI with control information and PUSCH with data. For example, a resource pool configuration may include the parameters that indicate a resource size for small data transmission (e.g., a PUSCH transmission is confined within this size). The resource size for a PUSCH transmission carrying a MAC PDU may be configured with X symbols or a slot or a mini-slot in time and Y PRBs in frequency. The PUSCH carrying the MAC PDU may include data payload or one or more control messages such as a MAC CE, an RLC Status PDU, a PDCP control PDU, or RRC messages (e.g. UE assistance information (UAI) message or RRC complete/failure message), or the like. The size of the UCI may also be specified or configured (e.g., S′ symbols in time and R′ PRBs in frequency). The UCI may contain a logical channel ID (e.g., a data logical channel associated with a QoS flow, a logical channel for a MAC CE, or a logical channel for an RRC message), HARQ parameters, MCS, or other information for decoding the PUSCH. The resource pool configuration may also include the parameters that indicate small data transmission allocations in time and frequency. For example, the parameters may include a periodicity (e.g., period) with transmission allocations over shared resources, a quantity P of transmission occasions in time with the periodicity, and a quantity Q of transmission occasions in frequency within a shared resource pool.

In some aspects, the UE may select time and frequency resources based at least in part on a resource pool configuration (e.g., X, Y, P, Q), shown in example 700. For example, the UE may select a time resource (e.g., in a slot, a mini-slot, or a symbol) for a small data transmission based at least in part on DATA_{slot/mini-slot/symbol}=(UE_ID₁ mod P)×X_{slot/mini-slot/symbol}. Based at least in part on the selected time allocation (e.g., DATAₛₗₒₜ in slot or DATAₘᵢₙᵢ₋ₛₗₒₜ in mini-slot), a UE may transmit a small data at the selected slot or mini-slot (e.g., PUSCH1 or PUSCH2 at the first slot or mini-slot) within a period of a shared resource pool.

In some aspects, the UE may select Y PRBs for the small data transmission based at least in part on DATA_{PRB}=(UE_ID₂ mod Q)×Y_{PRB}. In another example, the UE may randomly select Y PRBs within the Q frequency allocations based at least in part on random (Q)×Y, where a UE ID may be associated with a random seed). Based at least in part on the selected frequency allocation (e.g., DATA_{PRB}), a UE may transmit a small data at the selected PRBs (e.g., PUSCH1 at the first frequency allocation or PUSCH2 at the second frequency allocation) within a shared resource pool.

As indicated above, FIG. 7 is provided as an example. Other examples may differ from what is described with regard to FIG. 7.

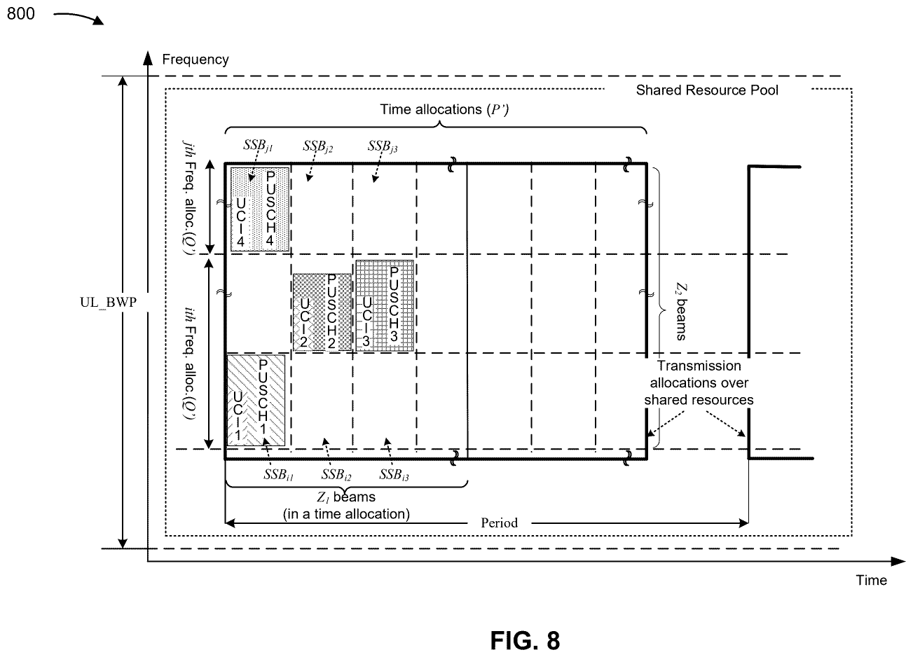

FIG. 8 is a diagram illustrating an example 800 of SSB-based resource allocations, in accordance with the present disclosure.

In some aspects, a UE may reduce blind beam sweeping at the network entity by selecting resources that are based at least in part on the beams associated with SSB transmissions of an SSB burst. For example, beam-based uplink small data transmission allocations may be based at least in part on allocations associated with TDMed beams. There may be P′ transmission occasions in time within a period of a shared resource pool, where each transmission occasion includes Z₁ beam time allocations associated with the beams corresponding to Z₁ SSBs. Beam-based uplink small data transmission allocations may be based at least in part on allocations of FDMed beams. There may be multiple Q′ transmission occasions in frequency, where each of the Q′ transmission occasions corresponds to a beam frequency allocation at a time that is associated with an SSB (e.g., Z₂ beam frequency allocations associated with the beams corresponding to Z₂ SSBs).

The UE may receive an indication of one or more resource pool configurations, where each resource pool configuration may indicate uplink transmission allocations that are based at least in part on beams associated with SSB transmissions. For example, resource selection may be based at least in part on the beam associated with the best selected SSB, (e.g., TDMed beams (different beams at different time allocations at a frequency allocation, such as the beams associated with SSBᵢ₁ and SSBᵢ₂ or SSBⱼ₁ and SSBⱼ₂) or FDMed beams (different beams at different frequency allocations at a time allocation, such as the beams associated with SSBᵢ₁ and SSBⱼ₁ or SSBᵢ₂ and SSBⱼ₂)), as shown by example 800.

In some aspects, the UE may select an uplink transmission allocation, which may include a time resource that is based at least in part on a beam time allocation associated with a beam of an SSB transmission. For example, the UE may select a beam time allocation slot or mini-slot corresponding to an SSBₖ (e.g., SSBᵢ₁ or SSBᵢ₂ within the ith Q′ frequency allocations or SSBⱼ₁ or SSBⱼ₂ within the jth Q′ frequency allocations) within a time allocation (e.g., the first time allocation of the P′ time allocations) for a small data transmission based at least in part on DATA_{slot,SSBk}=(UE_ID1 mod P′)×X_{slot,SSBk}. Based at least in part on the selected beam time allocation slot or mini-slot within a small data time allocation, a UE may transmit a small data at the slot or mini-slot of the selected small data beam time allocation (e.g., the PUSCH1 slot or mini-slot associated with SSBᵢ₁ or the PUSCH2 slot or mini-slot associated with SSBᵢ₂) within a period of a shared resource pool.

In some aspects, the UE may select uplink transmission allocation, which may include a frequency resource that is based at least in part on a beam frequency allocation associated with a beam of an SSB transmission. For example, the UE may select a beam frequency allocation corresponding to an SSBₗ (e.g., SSBᵢ₁ at the first beam time allocation or SSBᵢ₂ or SSBⱼ₂ at the second beam time allocation) within a time allocation (e.g., the first time allocation of the P′ time allocations) for a small data transmission based at least in part on DATA_{PRB, SSBl}=(UE_ID2 mod Q′)×Y_{PRB,SSBl}. In another example, the UE may randomly select a beam frequency allocation corresponding to an SSBₗ (e.g., SSBᵢ₁ or SSBⱼ₁ at the first beam time allocation or SSBᵢ₂ or SSBⱼ₂ at the second beam time allocation) within a time allocation (e.g., the first time allocation) for a small data transmission based at least in part on DATA_{PRB,SSBj}=random (Q′)×Y_{PRB,SSBj}. In this case, the UE may randomly select Y PRBs within the ith Q′ beam frequency allocations (e.g., corresponding to SSBᵢ) or Y PRBs within the jth Q′ beam frequency allocations (e.g., corresponding to SSBⱼ). Based at least in part on the selected beam frequency allocation with a Q′ beam frequency allocations (e.g., the ith Q′ beam frequency allocations or the jth Q′ beam frequency allocations), a UE may transmit a small data at the Y PRBs of the selected beam frequency allocation (e.g., the PUSCH1 PRBs associated with SSBᵢ₁ or the PUSCH4 PRBs associated with SSBⱼ₁) at a beam time allocation (e.g., the first beam time slot or mini-slot) of a shared resource pool.

As indicated above, FIG. 8 is provided as an example. Other examples may differ from what is described with regard to FIG. 8.

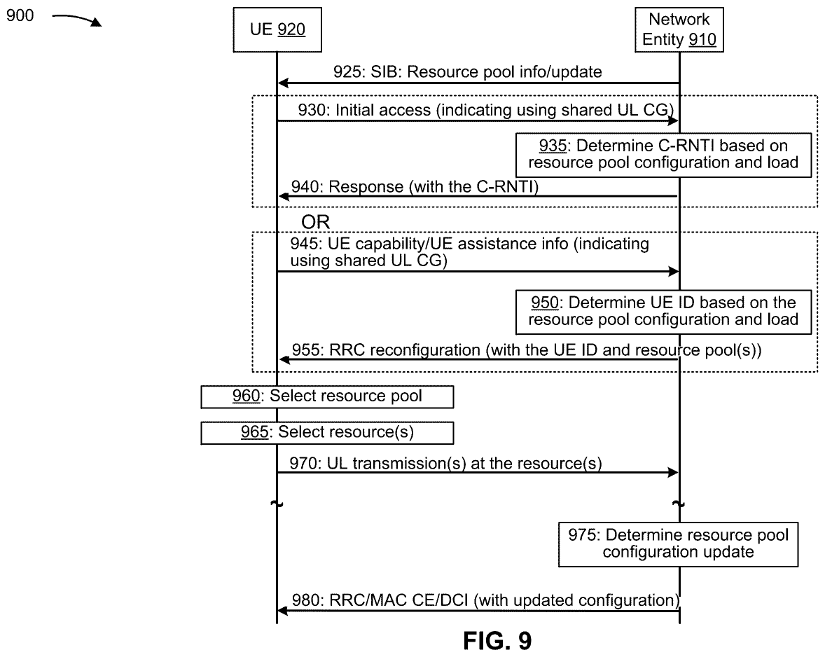

FIG. 9 is a diagram illustrating an example 900 of resource pool management, in accordance with the present disclosure. A UE 920 (e.g., UE 120) may communicate with a network entity 910 (e.g., network node 110) via a wireless communication (e.g., wireless communication network 100).

In some aspects, the network entity 910 may determine a resource pool configuration based at least in part on the number of UEs sharing CG resources within the resource pool and the traffic loading of the resource pool. The network entity 910 may determine the number of resource pools with different resource pool configurations and update (e.g., via a broadcast system information block one (SIB1)) one or more resource pool configurations for the UE 920, as shown by reference number 925.

As shown by reference number 930, the UE 920 may transmit an initial access message (indicated using a shared UL CG) to the network entity 910. The UE 920 may indicate the usage of a shared uplink grant (e.g., burst data with a quality of service (QoS) or a small data or control message). As shown by reference number 935, the network entity 910 may determine a C-RNTI (e.g., to reduce possible transmission allocation overlapping with other transmission allocations associated with other C-RNTIs) based at least in part on one or more resource pool configurations (each resource pool configuration includes the parameters for transmission allocations (e.g., as described in details in the connection with FIGS. 5-8)) and the traffic load on the one or more resource pools. As shown by reference number 940, the network entity 910 may transmit a response with the determined C-RNTI.

Alternatively, the UE 920 may transmit a UE capability (or UE assistance information) that indicates using a shared UL CG, as shown by reference number 945. The network entity 910 may select the UE ID based at least in part on reducing possible transmission allocation overlapping with other transmission allocations associated with other IDs within one or more resource pool configurations and the traffic loading on each resource pool, as shown by reference number 950. The network entity 910 may transmit an RRC reconfiguration that indicates the selected UE ID and one or more resource pool configurations, as shown by reference number 955, where each resource pool configuration contains the parameters for transmission allocations (e.g., as described in details in the connection with FIGS. 5-8).

As shown by reference number 960, the UE 920 may select a resource pool based at least in part on its UL transmission type (e.g., an UL transmission with small data or control message or an UL transmission with burst data and the associated QoS (e.g., the latency requirement such as packet delay budget (PDB)). For example, the UE 920 may select a resource pool suitable for small data or control message transmission or select a resource pool suitable for burst data transmission. In another example, the UE 920 may select a resource pool based at least in part on latency (e.g., select a resource pool with the earliest possible transmission allocation (e.g., based on the UE ID based mapping) or with more transmission allocations (e.g., more UCI transmission allocation within a period)) or more frequent transmission allocations (e.g., short period).

As shown by reference number 965, the UE 920 may select a transmission allocation in time and frequency within the selected resource pool based at least in part on the configured parameters for transmission allocation (e.g., as described in details in the connection with FIGS. 5-8). The transmission allocation may be based at least in part on a UE ID (e.g., as described in details in the connection with FIGS. 6-8) or a beam allocation that is based at least in part on a selected SSB (e.g., as described in details in the connection with FIGS. 6 and 8). The UE 920 may select a transmission allocation based at least in part on the timeline satisfying the QoS (e.g., the allocation that satisfies the remaining PDB).

As shown by reference number 970, the UE 920 may transmit an uplink transmission (e.g., a UCI transmission indicating a PUSCH transmission, small data transmission with both UCI and PUSCH) based at least in part on the selected transmission allocation. The network entity 910 may monitor uplink transmission(s) at the corresponding transmission allocation(s). In some aspects, the UE 920 may transmit a UCI that indicates time and frequency resources for a PUSCH message including burst data. In some aspects, the UE 920 may transmit the UCI with the PUSCH message including small data or control message.

As shown by reference number 975, the network entity 910 may determine a resource pool configuration update to one or more resource pools based at least in part on the number of UEs, resource pool traffic loading, transmissions using share UL configured grant, or a combination thereof. As shown by reference number 980, the network entity 910 may transmit an indication of the resource pool configuration update (e.g., via an RRC message with one or more resource pool configurations containing updated parameter values, a MAC CE or DCI to activate or deactivate one or more parameter values configured in a resource pool configuration (e.g., activate a new value for period or quantity of time allocation or quantity for frequency allocation, or the alike)).

As indicated above, FIG. 9 is provided as an example. Other examples may differ from what is described with regard to FIG. 9.

FIG. 10 is a diagram illustrating an example process 1000 performed, for example, at a UE or an apparatus of a UE, in accordance with the present disclosure. Example process 1000 is an example where the apparatus or the UE (e.g., UE 920) performs operations associated with resource pool configuration for a shared CG.

As shown in FIG. 10, in some aspects, process 1000 may include receiving an ID for the UE and a resource pool configuration associated with a configured grant shared by multiple UEs (block 1010). For example, the UE (e.g., using reception component 1202 or communication manager 1206, depicted in FIG. 12) may receive an ID for the UE and a resource pool configuration associated with a configured grant shared by multiple UEs, as described above.

As further shown in FIG. 10, in some aspects, process 1000 may include transmitting an uplink transmission based at least in part on the ID and the resource pool configuration (block 1020). For example, the UE (e.g., using transmission component 1204 or communication manager 1206, depicted in FIG. 12) may transmit an uplink transmission based at least in part on the ID and the resource pool configuration, as described above.

Process 1000 may include additional aspects, such as any single aspect or any combination of aspects described below or in connection with one or more other processes described elsewhere herein.

In a first aspect, the resource pool configuration indicates a size of the uplink transmission.

In a second aspect, alone or in combination with the first aspect, the resource pool configuration indicates uplink transmission occasions in time within a resource pool.

In a third aspect, alone or in combination with one or more of the first and second aspects, the resource pool configuration indicates uplink transmission occasions in frequency within a resource pool.

In a fourth aspect, alone or in combination with one or more of the first through third aspects, process 1000 includes selecting an uplink transmission occasion based at least in part on the ID and the resource pool configuration.

In a fifth aspect, alone or in combination with one or more of the first through fourth aspects, selecting the uplink transmission occasion includes selecting a time resource for the uplink transmission occasion based at least in part on one or more parameters for transmission allocations in time.

In a sixth aspect, alone or in combination with one or more of the first through fifth aspects, the one or more parameters include a quantity M of the transmission allocations in time and a parameter G of a transmission occasion gap in time, and selecting the time resource includes selecting the time resource based at least in part on (ID mod M)×G.

In a seventh aspect, alone or in combination with one or more of the first through sixth aspects, selecting the uplink transmission occasion includes selecting a frequency resource for the uplink transmission occasion based at least in part on a one or more parameters for transmission allocations in frequency.

In an eighth aspect, alone or in combination with one or more of the first through seventh aspects, the one or more parameters include a quantity N of transmission allocations in frequency and a quantity R of PRBs, and selecting the frequency resource includes selecting the frequency resource based at least in part on (ID mod N)×R.

In a ninth aspect, alone or in combination with one or more of the first through eighth aspects, the one or more parameters include a quantity N of transmission allocations in frequency and a quantity R of PRBs, where selecting the frequency resource includes selecting the frequency resource based at least in part on (a random number from N)×R.

In a tenth aspect, alone or in combination with one or more of the first through ninth aspects, the resource pool configuration indicates that uplink transmission allocations are based at least in part on beams associated with SSB transmissions.

In an eleventh aspect, alone or in combination with one or more of the first through tenth aspects, the uplink transmission allocations include a time resource that is based at least in part on a time allocation associated with a beam of an SSB transmission.

In a twelfth aspect, alone or in combination with one or more of the first through eleventh aspects, the uplink transmission allocations include a frequency resource that is based at least in part on a frequency allocation associated with a beam of an SSB transmission.

In a thirteenth aspect, alone or in combination with one or more of the first through twelfth aspects, transmitting the uplink transmission includes transmitting a UCI that indicates a time resource and a frequency resource for a PUSCH message.

In a fourteenth aspect, alone or in combination with one or more of the first through thirteenth aspects, process 1000 includes transmitting the PUSCH message in the time resource and the frequency resource as indicated in the UCI.

In a fifteenth aspect, alone or in combination with one or more of the first through fourteenth aspects, transmitting the uplink transmission includes transmitting a UCI with a PUSCH message.

In a sixteenth aspect, alone or in combination with one or more of the first through fifteenth aspects, the PUSCH message includes a small data or one or more control messages.

In a seventeenth aspect, alone or in combination with one or more of the first through sixteenth aspects, the UCI includes a logical channel identifier.

In an eighteenth aspect, alone or in combination with one or more of the first through seventeenth aspects, process 1000 includes selecting a resource pool based at least in part on the resource pool configuration, where the resource pool configuration is associated with one or more resource pools.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a network entity or an apparatus of a network entity, in accordance with the present disclosure. Example process 1100 is an example where the apparatus or the network entity (e.g., network entity 910) performs operations associated with resource pool configuration for a shared CG.

As shown in FIG. 11, in some aspects, process 1100 may include transmitting an ID for a UE and a resource pool configuration associated with a configured grant shared by multiple UEs (block 1110). For example, the network entity (e.g., using transmission component 1304 or communication manager 1306, depicted in FIG. 13) may transmit an ID for a UE and a resource pool configuration associated with a configured grant shared by multiple UEs, as described above.

As further shown in FIG. 11, in some aspects, process 1100 may include receiving, in association with the resource pool configuration, an uplink transmission (block 1120). For example, the network entity (e.g., using reception component 1302 or communication manager 1306, depicted in FIG. 13) may receive, in association with the resource pool configuration, an uplink transmission, as described above.

Process 1100 may include additional aspects, such as any single aspect or any combination of aspects described below or in connection with one or more other processes described elsewhere herein.

In a first aspect, receiving the uplink transmission includes receiving a UCI that indicates a time resource and a frequency resource for a PUSCH message.

In a second aspect, alone or in combination with the first aspect, process 1100 includes receiving the PUSCH message in the time resource and the frequency resource as indicated in the UCI.

In a third aspect, alone or in combination with one or more of the first and second aspects, receiving the uplink transmission includes receiving a UCI with a PUSCH message.

In a fourth aspect, alone or in combination with one or more of the first through third aspects, the PUSCH message includes a small data or one or more control messages.

In a fifth aspect, alone or in combination with one or more of the first through fourth aspects, the UCI includes a logical channel ID.

In a sixth aspect, alone or in combination with one or more of the first through fifth aspects, process 1100 includes selecting the ID for the UE based at least in part on the resource pool configuration, other IDs in a resource pool associated with the resource pool configuration, and a loading on each resource pool association with the resource pool configuration.

In a seventh aspect, alone or in combination with one or more of the first through sixth aspects, the resource pool configuration indicates a size of the uplink transmission.

In an eighth aspect, alone or in combination with one or more of the first through seventh aspects, the resource pool configuration indicates uplink transmission occasions in time within a resource pool.

In a ninth aspect, alone or in combination with one or more of the first through eighth aspects, the resource pool configuration indicates uplink transmission occasions in frequency within a resource pool.

In a tenth aspect, alone or in combination with one or more of the first through ninth aspects, the resource pool configuration indicates that uplink transmission allocations are based at least in part on beams associated with SSB transmissions.

In an eleventh aspect, alone or in combination with one or more of the first through tenth aspects, the uplink transmission allocations include a time resource that is based at least in part on a time allocation associated with a beam of an SSB transmission.

In a twelfth aspect, alone or in combination with one or more of the first through eleventh aspects, the uplink transmission allocations include a frequency resource that is based at least in part on a frequency allocation associated with a beam of an SSB transmission.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication. The apparatus 1200 may be a UE, or a UE may include the apparatus 1200. In some aspects, the apparatus 1200 includes a reception component 1202, a transmission component 1204, or a communication manager 1206, which may be in communication with one another (for example, via one or more buses or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 140 described in connection with FIG. 1) of the UE.

In some aspects, the apparatus 1200 may be configured to perform one or more operations described herein in connection with FIGS. 1-9. Additionally, or alternatively, the apparatus 1200 may be configured to perform one or more processes described herein, such as process 1000 of FIG. 10. In some aspects, the apparatus 1200 or one or more components shown in FIG. 12 may include one or more components of the UE described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the UE described above in connection with FIG. 1, such as a radio, one or more RF chains, one or more transceivers, or one or more modems, each of which may in turn be coupled with one or more antennas of the UE.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1204 may be co-located with the reception component 1202.

The communication manager 1206 may support operations of the reception component 1202 or the transmission component 1204. For example, the communication manager 1206 may receive information associated with configuring reception of communications by the reception component 1202 or transmission of communications by the transmission component 1204. Additionally, or alternatively, the communication manager 1206 may generate or provide control information to the reception component 1202 or the transmission component 1204 to control reception or transmission of communications.

The reception component 1202 may receive an ID for the UE and a resource pool configuration associated with a configured grant shared by multiple UEs. The transmission component 1204 may transmit an uplink transmission based at least in part on the ID and the resource pool configuration.

The communication manager 1206 may select an uplink transmission occasion based at least in part on the ID and the resource pool configuration. The transmission component 1204 may transmit the PUSCH message in the time resource and the frequency resource as indicated in the UCI. The communication manager 1206 may select a resource pool based at least in part on the resource pool configuration, where the resource pool configuration is associated with one or more resource pools.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication. The apparatus 1300 may be a network entity, or a network entity may include the apparatus 1300. In some aspects, the apparatus 1300 includes a reception component 1302, a transmission component 1304, or a communication manager 1306, which may be in communication with one another (for example, via one or more buses or one or more other components). In some aspects, the communication manager 1306 is the communication manager 155 described in connection with FIG. 1. As shown, the apparatus 1300 may communicate with another apparatus 1308, such as a UE or a network node (such as a CU, a DU, an RU, or a base station), using the reception component 1302 and the transmission component 1304. The communication manager 1306 may be included in, or implemented via, a processing system (for example, the processing system 145 described in connection with FIG. 1) of the network entity.

In some aspects, the apparatus 1300 may be configured to perform one or more operations described herein in connection with FIGS. 1-9. Additionally, or alternatively, the apparatus 1300 may be configured to perform one or more processes described herein, such as process 1100 of FIG. 11. In some aspects, the apparatus 1300 or one or more components shown in FIG. 13 may include one or more components of the network entity described in connection with FIG. 1. Additionally, or alternatively, one or more components shown in FIG. 13 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications, and may provide the processed signals to the one or more other components of the apparatus 1300. In some aspects, the reception component 1302 may include one or more components of the network entity described above in connection with FIG. 1, such as a radio, one or more RF chains, one or more transceivers, or one or more modems, each of which may in turn be coupled with one or more antennas of the network entity.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications, and may transmit the processed signals to the apparatus 1308. In some aspects, the transmission component 1304 may include one or more components of the network entity described above in connection with FIG. 1, such as a radio, one or more RF chains, one or more transceivers, or one or more modems, each of which may in turn be coupled with one or more antennas of the network entity described in connection with FIG. 1. In some aspects, the transmission component 1304 may be co-located with the reception component 1302.

The communication manager 1306 may support operations of the reception component 1302 or the transmission component 1304. For example, the communication manager 1306 may receive information associated with configuring reception of communications by the reception component 1302 or transmission of communications by the transmission component 1304. Additionally, or alternatively, the communication manager 1306 may generate or provide control information to the reception component 1302 or the transmission component 1304 to control reception or transmission of communications.

The transmission component 1304 may transmit an ID for a UE and a resource pool configuration associated with a configured grant shared by multiple UEs. The reception component 1302 may receive, in association with the resource pool configuration, an uplink transmission.

The reception component 1302 may receive the PUSCH message in the time resource and the frequency resource as indicated in the UCI. The communication manager 1306 may select the ID for the UE based at least in part on the resource pool configuration, other IDs in a resource pool associated with the resource pool configuration, and a loading on each resource pool association with the resource pool configuration.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a user equipment (UE), comprising: receiving an identifier (ID) for the UE and a resource pool configuration associated with a configured grant shared by multiple UEs; and transmitting an uplink transmission based at least in part on the ID and the resource pool configuration.

Aspect 2: The method of Aspect 1, wherein the resource pool configuration indicates a size of the uplink transmission.

Aspect 3: The method of any of Aspects 1-2, wherein the resource pool configuration indicates uplink transmission occasions in time within a resource pool.

Aspect 4: The method of any of Aspects 1-3, wherein the resource pool configuration indicates uplink transmission occasions in frequency within a resource pool.

Aspect 5: The method of any of Aspects 1-4, further comprising selecting an uplink transmission occasion based at least in part on the ID and the resource pool configuration.

Aspect 6: The method of Aspect 5, wherein selecting the uplink transmission occasion includes selecting a time resource for the uplink transmission occasion based at least in part on one or more parameters for transmission allocations in time.

Aspect 7: The method of Aspect 6, wherein the one or more parameters include a quantity M of the transmission allocations in time and a parameter G of a transmission occasion gap in time, and wherein selecting the time resource includes selecting the time resource based at least in part on (ID mod M)×G.

Aspect 8: The method of Aspect 5, wherein selecting the uplink transmission occasion includes selecting a frequency resource for the uplink transmission occasion based at least in part on a one or more parameters for transmission allocations in frequency.

Aspect 9: The method of Aspect 8, wherein the one or more parameters include a quantity N of transmission allocations in frequency and a quantity R of physical resource blocks (PRBs), and wherein selecting the frequency resource includes selecting the frequency resource based at least in part on (ID mod N)×R.

Aspect 10: The method of Aspect 8, wherein the one or more parameters include a quantity N of transmission allocations in frequency and a quantity R of physical resource blocks (PRBs), wherein selecting the frequency resource includes selecting the frequency resource based at least in part on a (random number from N)×R.

Aspect 11: The method of any of Aspects 1-10, wherein the resource pool configuration indicates that uplink transmission allocations are based at least in part on beams associated with synchronization signal block (SSB) transmissions.

Aspect 12: The method of Aspect 11, wherein the uplink transmission allocations include a time resource that is based at least in part on a time allocation associated with a beam of an SSB transmission.

Aspect 13: The method of Aspect 11, wherein the uplink transmission allocations include a frequency resource that is based at least in part on a frequency allocation associated with a beam of an SSB transmission.

Aspect 14: The method of any of Aspects 1-13, wherein transmitting the uplink transmission includes transmitting an uplink control information (UCI) that indicates a time resource and a frequency resource for a physical uplink shared channel (PUSCH) message.

Aspect 15: The method of Aspect 14, further comprising transmitting the PUSCH message in the time resource and the frequency resource as indicated in the UCI.

Aspect 16: The method of any of Aspects 1-15, wherein transmitting the uplink transmission includes transmitting an uplink control information (UCI) with a physical uplink shared channel (PUSCH) message.

Aspect 17: The method of Aspect 16, wherein the PUSCH message includes a small data or one or more control messages.

Aspect 18: The method of Aspect 16, wherein the UCI includes a logical channel identifier.

Aspect 19: The method of any of Aspects 1-18, further comprising selecting a resource pool based at least in part on the resource pool configuration, wherein the resource pool configuration is associated with one or more resource pools.

Aspect 20: A method of wireless communication performed by a network entity, comprising: transmitting an identifier (ID) for a user equipment (UE) and a resource pool configuration associated with a configured grant shared by multiple UEs; and receiving, in association with the resource pool configuration, an uplink transmission.

Aspect 21: The method of Aspect 20, wherein receiving the uplink transmission includes receiving an uplink control information (UCI) that indicates a time resource and a frequency resource for a physical uplink shared channel (PUSCH) message.

Aspect 22: The method of Aspect 21, further comprising receiving the PUSCH message in the time resource and the frequency resource as indicated in the UCI.

Aspect 23: The method of Aspect 21, wherein receiving the uplink transmission includes receiving an uplink control information (UCI) with a physical uplink shared channel (PUSCH) message.

Aspect 24: The method of Aspect 23, wherein the PUSCH message includes a small data or one or more control messages.

Aspect 25: The method of Aspect 23, wherein the UCI includes a logical channel identifier.

Aspect 26: The method of any of Aspects 20-25, further comprising selecting the ID for the UE based at least in part on the resource pool configuration, other IDs in a resource pool associated with the resource pool configuration, and a loading on each resource pool association with the resource pool configuration.

Aspect 27: The method of any of Aspects 20-26, wherein the resource pool configuration indicates a size of the uplink transmission.

Aspect 28: The method of any of Aspects 20-27, wherein the resource pool configuration indicates uplink transmission occasions in time within a resource pool.

Aspect 29: The method of any of Aspects 20-28, wherein the resource pool configuration indicates uplink transmission occasions in frequency within a resource pool.

Aspect 30: The method of any of Aspects 20-29, wherein the resource pool configuration indicates that uplink transmission allocations are based at least in part on beams associated with synchronization signal block (SSB) transmissions.

Aspect 31: The method of Aspect 30, wherein the uplink transmission allocations include a time resource that is based at least in part on a time allocation associated with a beam of an SSB transmission.

Aspect 32: The method of Aspect 30, wherein the uplink transmission allocations include a frequency resource that is based at least in part on a frequency allocation associated with a beam of an SSB transmission.

Aspect 33: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-32.

Aspect 34: An apparatus for wireless communication at a device, the apparatus comprising one or more memories and one or more processors coupled to the one or more memories, the one or more processors configured to cause the device to perform the method of one or more of Aspects 1-32.

Aspect 35: An apparatus for wireless communication, the apparatus comprising at least one means for performing the method of one or more of Aspects 1-32.

Aspect 36: A non-transitory computer-readable medium storing code for wireless communication, the code comprising instructions executable by one or more processors to perform the method of one or more of Aspects 1-32.

Aspect 37: A non-transitory computer-readable medium storing a set of instructions for wireless communication, the set of instructions comprising one or more instructions that, when executed by one or more processors of a device, cause the device to perform the method of one or more of Aspects 1-32.

Aspect 38: A device for wireless communication, the device comprising a processing system that includes one or more processors and one or more memories coupled with the one or more processors, the processing system configured to cause the device to perform the method of one or more of Aspects 1-32.

Aspect 39: An apparatus for wireless communication at a device, the apparatus comprising one or more memories and one or more processors coupled to the one or more memories, the one or more processors individually or collectively configured to cause the device to perform the method of one or more of Aspects 1-32.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive an identifier (ID) for the UE and a resource pool configuration associated with a configured grant shared by multiple UEs; and
transmit an uplink transmission based at least in part on the ID and the resource pool configuration.

2. The UE of claim 1, wherein the resource pool configuration indicates a size of the uplink transmission.

3. The UE of claim 1, wherein the resource pool configuration indicates uplink transmission occasions in time within a resource pool.

4. The UE of claim 1, wherein the resource pool configuration indicates uplink transmission occasions in frequency within a resource pool.

5. The UE of claim 1, wherein the processing system is configured to cause the UE to select an uplink transmission occasion based at least in part on the ID and the resource pool configuration.

6. The UE of claim 5, wherein to select the uplink transmission occasion, the processing system is configured to cause the UE to select a time resource for the uplink transmission occasion based at least in part on one or more parameters for transmission allocations in time.

7. The UE of claim 6, wherein the one or more parameters include a quantity M of the transmission allocations in time and a parameter G of a transmission occasion gap in time, and wherein selecting the time resource includes selecting the time resource based at least in part on (ID mod M)×G.

8. The UE of claim 5, wherein to select the uplink transmission occasion, the processing system is configured to cause the UE to select a frequency resource for the uplink transmission occasion based at least in part on a one or more parameters for transmission allocations in frequency.

9. The UE of claim 8, wherein the one or more parameters include a quantity N of transmission allocations in frequency and a quantity R of physical resource blocks (PRBs), and wherein selecting the frequency resource includes selecting the frequency resource based at least in part on (ID mod N)×R.

10. The UE of claim 8, wherein the one or more parameters include a quantity N of transmission allocations in frequency and a quantity R of physical resource blocks (PRBs), wherein selecting the frequency resource includes selecting the frequency resource based at least in part on a (random number from N)×R.

11. The UE of claim 1, wherein the resource pool configuration indicates that uplink transmission allocations are based at least in part on beams associated with synchronization signal block (SSB) transmissions.

12. The UE of claim 11, wherein the uplink transmission allocations include a time resource that is based at least in part on a time allocation or a frequency allocation associated with a beam of an SSB transmission.

13. The UE of claim 1, wherein to transmit the uplink transmission, the processing system is configured to cause the UE to transmit an uplink control information (UCI) that indicates a time resource and a frequency resource for a physical uplink shared channel (PUSCH) message.

14. The UE of claim 13, wherein the processing system is configured to cause the UE to transmit the PUSCH message in the time resource and the frequency resource as indicated in the UCI.

15. The UE of claim 1, wherein to transmit the uplink transmission, the processing system is configured to cause the UE to transmit an uplink control information (UCI) with a physical uplink shared channel (PUSCH) message.

16. The UE of claim 15, wherein the PUSCH message includes a small data or one or more control messages.

17. The UE of claim 15, wherein the UCI includes a logical channel identifier.

18. The UE of claim 1, wherein the processing system is configured to cause the UE to select a resource pool based at least in part on the resource pool configuration, wherein the resource pool configuration is associated with one or more resource pools.

19. A network entity, comprising:
a processing system that includes one or more processors and one or more code-storing memories coupled with the one or more processors, the processing system configured to cause the network entity to:
transmit an identifier (ID) for a user equipment (UE) and a resource pool configuration associated with a configured grant shared by multiple UEs; and
receive, in association with the resource pool configuration, an uplink transmission.

20. The network entity of claim 19, wherein to receive the uplink transmission, the processing system is configured to cause the network entity to receive an uplink control information (UCI) that indicates a time resource and a frequency resource for a physical uplink shared channel (PUSCH) message.
